(19) United States
(12) Patent Application Publication
(10) Pub. No.: US 2021/0208248 A1
(43) Pub. Date: Jul. 8, 2021

(54) POSTURE DETECTION METHOD

(71) Applicant: Sil Radar Technology Inc., Kaohsiung City (TW)

(72) Inventors: Yi-Ting Tseng, Kaohsiung City (TW); Sheng-You Tian, Kaohsiung City (TW)

(21) Appl. No.: 17/128,317

(22) Filed: Dec. 21, 2020

(30) Foreign Application Priority Data
Jan. 3, 2020 (TW) 109100226

(51) Int. Cl. G01S 7/41; G01S 13/58

(52) U.S. Cl. CPC G01S 7/415; G01S 13/584

(57) ABSTRACT

A FMCW radar is provided to detect momentum intensities of detection distances in a region and compute a momentum feature time-domain function of a feature distance composed of multiple detection distances in a posture detection method. The momentum feature time-domain function can represent displacement variation occurred at the feature distance so as to estimate object posture with benefits of interference avoidance and high privacy protection.

### FIELD OF THE INVENTION

This invention generally relates to a detection method, and more particularly to a posture detection method.

### BACKGROUND OF THE INVENTION

Long-term care receives more and more attention, and techniques for instant monitoring of vital signs are rapidly growing in health monitoring system. Radar is better than image capture device for vital sign monitoring because of advantages of precise detection, obstruction avoidance and high privacy protection. Radar used for vital sign monitoring may be continuous-wave (CW) radar or pulsed radar, and CW radar involves direct-conversion continuous-wave radar, self-injection-locked radar and frequency-modulated continuous wave (FMCW) radar, and so on. Conventional CW radar can detect tiny vibration caused by vital signs, such as respiration and heartbeat, but cannot detect posture and motion having large displacement so it is not applicable to detect some life-threatening conditions. For example, people falling on floor and disabled patient not lying on the bed cannot be detected by the conventional CW radar because their vital signs are in normal range.

### SUMMARY

The object of the present invention is to provide a posture detection method in which a momentum feature time-domain function of feature distance generated by momentum intensities of multiple detection distances is provided to estimate object posture.

A detection method of the present invention includes a step (a) of transmitting a wireless signal to a region and receiving a reflected signal from the region as a detection signal by a frequency-modulated continuous wave (FMCW) radar; a step (b) of receiving the detection signal including a plurality of time segments and dividing one of the time segments of the detection signal into a plurality of short-time detection segments by a processor; a step (c) of analyzing spectrum characteristics of the short-time detection segments and reconfiguring components of the same frequency of each of the short-time detection segments into a plurality of detection sub-signals by the processor, wherein each of the detection sub-signals corresponds to a detection distance; a step (d) of computing a momentum intensity of the detection distance corresponding to each of the detection sub-signals by the processor according to a amplitude of each of the detection sub-signals; a step (e) of proceeding the steps (b) to (d) repeatedly to compute momentum intensities of detection distances of the other time segments of the detection signal by the processor; a step (f) of defining more than one of the detection distances as a feature distance, computing a momentum feature of the feature distance according to the momentum intensities of the feature distance and composing the momentum feature of the different time segments into a momentum feature time-domain function of the feature distance by the processor; and a step (g) of estimating a posture of an object in the region by the processor according to the momentum feature time-domain function of the feature distance.

In the present invention, the momentum intensities of the detection distances obtained by the FMCW radar are provided to compute the momentum feature time-domain function of the feature distance composed of the multiple detection distances so as to estimate object posture without problems of obstruction and privacy invasion.

### DESCRIPTION OF THE DRAWINGS

FIG. 1 is a flowchart illustrating a posture detection method in accordance with one embodiment of the present invention.

FIG. 2 is a block diagram illustrating a FMCW radar and a processor in accordance with one embodiment of the present invention.

FIG. 3 is a circuit diagram illustrating the FMCW radar in accordance with one embodiment of the present invention.

FIG. 4 is a diagram illustrating steps (b) to (d) performed by the processor in accordance with one embodiment of the present invention.

FIG. 5 is a diagram illustrating a step (f) performed by the processor in accordance with one embodiment of the present invention.

FIG. 6 is a diagram illustrating a movement of a human body in accordance with one embodiment of the present invention.

FIG. 7 is a diagram illustrating a movement of a human body in accordance with one embodiment of the present invention.

### DETAILED DESCRIPTION OF THE INVENTION

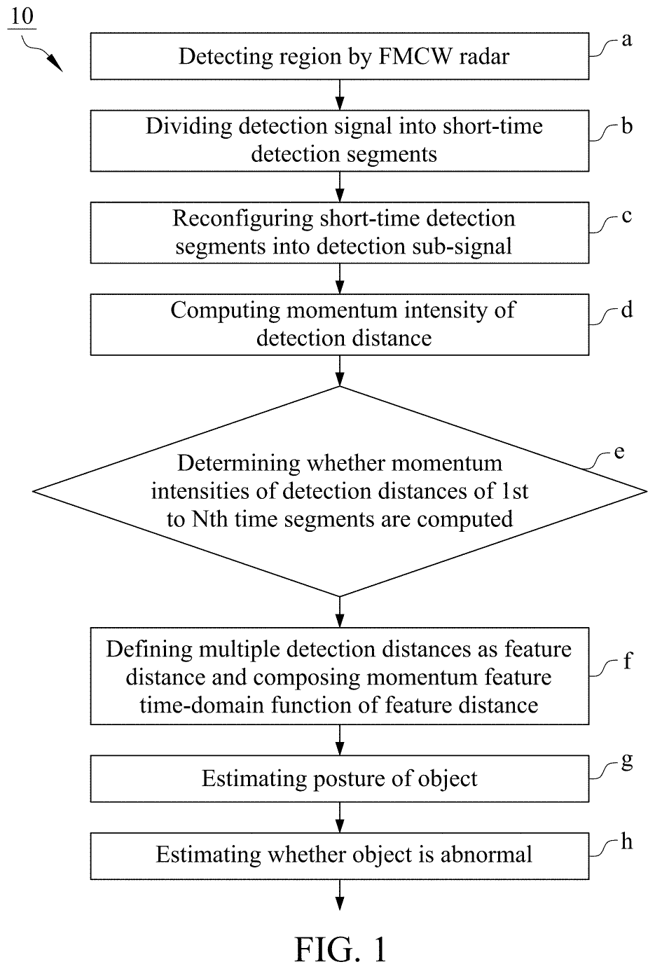

With reference to FIG. 1, a posture detection method 10 in accordance with one embodiment of the present invention includes steps as follows: step (a) of detecting region by FMCW radar, step (b) of dividing detection signal into short-time detection segments, step (c) of reconfiguring short-time detection segments into detection sub-signal, step (d) of computing momentum intensity of detection distance, step (e) of determining whether momentum intensities of detection distances of 1^{st} to N^{th} time segments are computed, step (f) of defining multiple detection distances as feature distance and composing momentum feature time-domain function of feature distance, step (g) of estimating posture of object and step (h) of estimating whether object is abnormal.

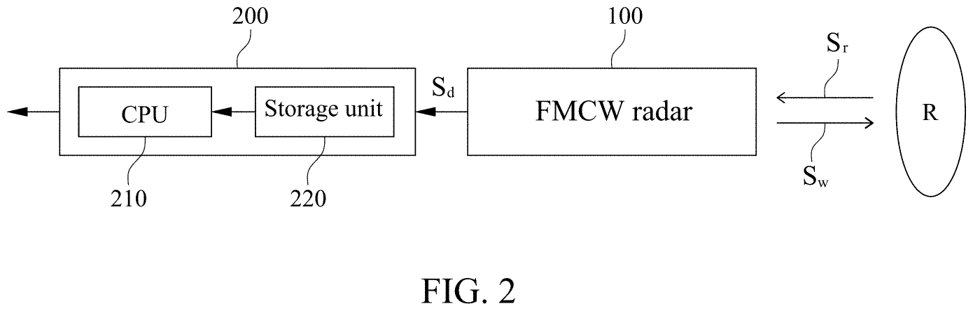

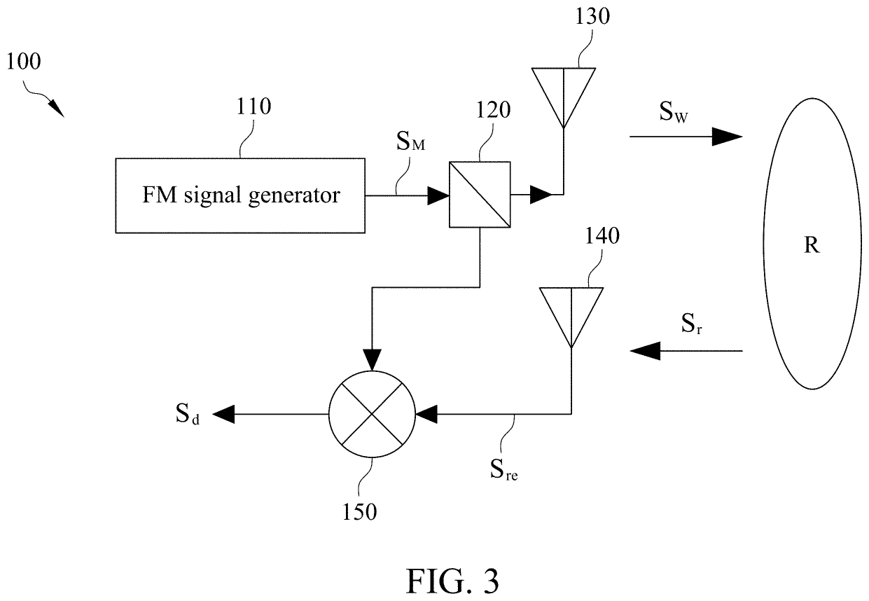

With reference to FIGS. 1 and 2, a FMCW radar 100 transmits a wireless signal S_{w} to a region R and receives a reflected signal Sᵣ from the region R as a detection signal S_{d} in the step (a). The FMCW radar 100 in accordance with one embodiment of the present invention is shown in FIG. 3, it includes a FM signal generator 110, a power splitter 120, a transmitting antenna 130, a receiving antenna 140 and a mixer 150. The FM signal generator 110 outputs a frequency-modulated signal S_{M}. The power splitter 120 is electrically connected to the FM signal generator 110 and divides the frequency-modulated signal S_{M} into two paths. The transmitting antenna 130 is electrically connected to the power splitter 120 in order to receive and transmit the frequency-modulated signal S_{M} of one path to the region R as the wireless signal S_{w}. The receiving antenna 140 receives the reflected signal Sᵣ from the region R as a received signal S_{M}. The mixer 150 is electrically connected to the power splitter 120 and the receiving antenna 140, and receives and mix the frequency-modulated signal S_{M} of the other path and the received signal Sᵣₑ to output the detection signal S_{d}.

The FMCW radar 100 detects the region R by transmitting the wireless signal S_{w} changed in frequency over time, consequently, object within the region R at different distances from the FMCW radar 100 can be detected using the time difference between the wireless signal S_{w} and the reflected signal Sᵣ having the same frequency.

With reference FIG. 2, a processor 200 is provided to receive the detection signal S_{d} for the follow-up steps. In this embodiment, the processor 200 includes a central processing unit 210 and a storage unit 220. The storage unit 220 is electrically connected to the FMCW radar 100 and configured to receive and storage the detection signal for a period of time. The central processing unit 210 is electrically connected to the storage unit 220 to receive the storage detection signal S_{d} for operation.

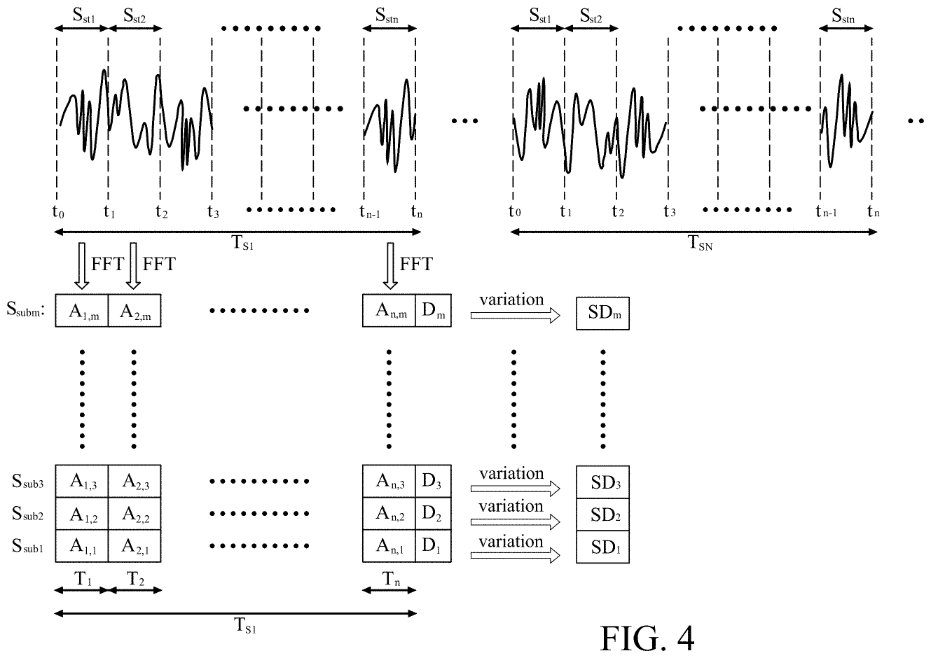

With reference to FIGS. 1, 2 and 4, the processor 200 receives the detection signal S_{d} including multiple time segments T_{S1}˜T_{SN} and divides one of the time segments of the detection signal S_{d} into multiple short-time detection segments Sₛₜ₁˜Sₛₜₙ in the step (b). FIG. 4 presents an example of the first time segment T_{S1} divided by the processor 200, the first time segment T_{S1} of the detection signal S_{d} is divided into the short-time detection segments Sₛₜ₁˜Sₛₜₙ at the same time interval t₀˜t₁, t₁˜t₂ . . . tₙ₋₁˜tₙ.

With reference to FIGS. 1, 2 and 4, the processor 200 analyzes spectrum characteristics of the short-time segments Sₛₜ₁˜Sₛₜₙ and reconfigures components having the same frequency of each of the short-time segments Sₛₜ₁˜Sₛₜₙ into multiple detection sub-signals S_{sub1}˜S_{subm} that correspond to detection distances D₁˜Dₘ, respectively in the step (c). As shown in FIG. 4, the processor 200 obtains amplitudes of frequency components of each of the short-time detection segments Sₛₜ₁˜Sₛₜₙ by using a fast Fourier transform (FFT), where the columns are the frequency components of each of the short-time detection segments Sₛₜ₁˜Sₛₜₙ and the rows are the detection sub-signals S_{sub1}˜S_{subm} reconfigured by the components having the same frequency. For instance, A_{1,1} is the amplitude of the 1^{st} frequency of the 1^{st} short-time detection segment Sₛₜ₁, A_{1,m} is the amplitude of m^{th} frequency of the 1st short-time detection segment Sₛₜ₁, A_{n,1} is the amplitude of the 1st frequency of the n^{th} short-time detection segment Sₛₜₙ, and A_{n,m} is the amplitude of the m^{th} frequency of the n^{th} short-time detection segment Sₛₜₙ. In this embodiment, due to the region R is detected using the FMCW radar 100, the amplitudes of the detection sub-signals S_{sub1}˜S_{subm} having the same frequency can be used to represent the displacements of the object at the detection distances D₁˜Dₘ, respectively.

Preferably, the detection distances D₁˜Dₘ corresponding to the detection sub-signals S_{sub1}˜S_{subm} can be calculated using the formula as follows in this embodiment:

$$R = \frac{{c}_{0} \cdot \vert Δ f \vert}{2 \cdot ( df / dt )}$$

where R is the detection distances D₁˜Dₘ corresponding to the detection sub-signals S_{sub1}˜S_{subm}, c₀ is the speed of light of 3·10⁸ m/s, Δf is the frequency of the detection sub-signals S_{sub1}˜S_{subm}, and (df/dt) is the slope of the frequency variation of the wireless signal S_{w}.

With reference to FIGS. 1, 2 and 4, the processor 200 computes momentum intensities of the detection distances D₁˜Dₘ corresponding to the detection sub-signals S_{sub1}˜S_{subm} using the amplitudes of the detection sub-signals S_{sub1}˜S_{subm} in the step (d). With reference to FIG. 4, a discrete degree of the amplitude of each of the detection sub-signals S_{sub1}˜S_{subm}, e.g. variance, standard deviation or quartile range, can be used to represent the momentum intensity of each of the detection distances D₁˜Dₘ. In this embodiment, the processor 200 computes a standard deviation of the amplitude of each of the detection sub-signals S_{sub1}˜S_{subm} as the momentum intensity of each of the detection distances D₁˜Dₘ, and the standard deviation SD_{1˜m} of the amplitude of each of the detection sub-signals S_{sub1}˜S_{subm} is computed using the formula as follows:

$$S {D}_{1 ∼ m} = \sqrt{\frac{1}{n} {\sum }_{i = 1}^{n} {( {x}_{i} - μ )}^{2}}$$

where SD_{1˜m} is the standard deviation of the amplitude of each of the detection sub-signals S_{sub1}˜S_{subm}, xᵢ is the amplitude of each components of each of the detection sub-signals S_{sub1}˜S_{subm}, μ is the amplitude average value of all components of each of the detection sub-signals S_{sub1}˜S_{subm}. The standard deviation SD_{1˜m} of the amplitude of each of the detection sub-signals S_{sub1}˜S_{subm} can represent the displacement variation of the object at each of the corresponding detection distances D₁˜Dₘ, for this reason, the standard deviation SD_{1˜m} is used as the momentum intensity of each of the detection distances D₁˜Dₘ in this embodiment.

With reference to FIGS. 1, 2 and 4, in the step (e), the processor 200 determines whether the momentum intensities of the detection distances D₁˜Dₘ of the 1st to N^{th} time segments T_{S1}˜T_{SN} are all computed. If the computation is not completed, the processor 200 proceeds the steps (b) to (d) repeatedly to compute the momentum intensities of the detection distances D₁˜Dₘ of the time segments T_{S1}˜T_{SN} of the detection signal S_{d} that is stored in the storage unit 220. The more the time segments T_{S1}˜T_{SN} are divided, the higher resolution of posture identification can be obtained. However, the number N of the time segments T_{S1}˜T_{SN} is proportional to the computing time required on the processor 200, thus the number N has to be adjusted according to user requirement or computing power of the central processing unit 210 and the storage unit 220. The number N of the divided time segments T_{S1}˜T_{SN} is not limited in the present invention.

With reference to FIGS. 1, 2 and 5, the posture of the object O in the region R may affect momentum intensities of multiple detection distances at the same time, and two different postures of the object O may generate the same momentum intensity at the same detection distance. Thus, the momentum intensity of a single detection distance is not sufficient enough to identify object's posture precisely. In the step (f), in order to identify the posture precisely, the processor 200 defines the multiple detection distances as a feature distance D_{feature}, computes a momentum feature SD_{feature} of the feature distance D_{feature} according to the multiple momentum intensities corresponding to the feature distance D_{feature} and composes a momentum feature time-domain function SD_{feature}(t) using the momentum features SD_{feature}(T_{S1})˜SD_{feature}(T_{SN}) of the different time segments T_{S1}˜T_{SN}.

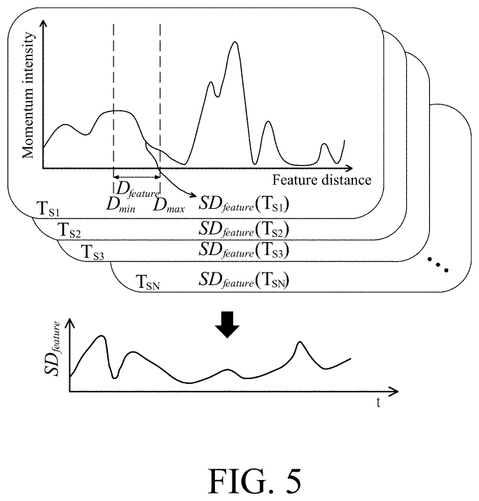

With reference to FIG. 5, in this embodiment, the multiple detection distances between the minimum detection distance Dₘᵢₙ and the maximum detection distance Dₘₐₓ are defined as the feature distance D_{feature}, and the momentum intensities of the multiple detection distances are used to compute the momentum feature SD_{feature} of the feature distance D_{feature}. Preferably, the processor 200 computes an average value of the momentum intensities of the multiple detection distances defined as the feature distance D_{feature}, and the average value is regarded as the momentum feature SD_{feature} of the feature distance D_{feature}.

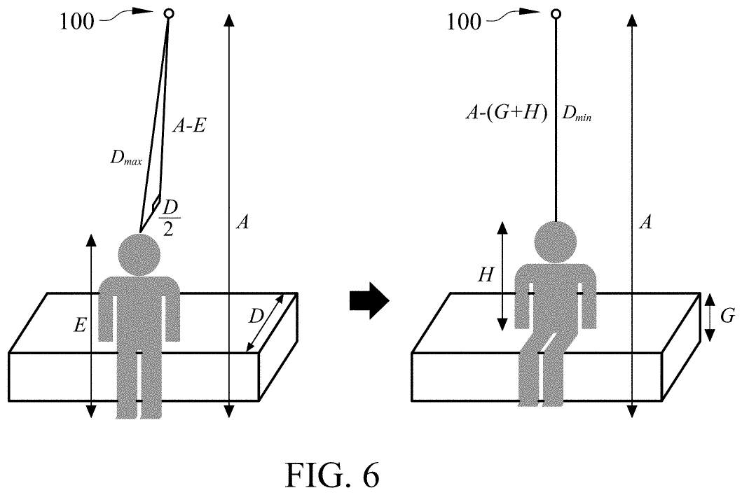

The posture of the object O is continuous motion covering multiple detection distances. In this embodiment, the detection distances defined as the feature distance D_{feature} are the different distances from the object O to the FMCW radar 100 during posture, consequently, the processor 200 can compute the maximum detection distance Dₘₐₓ and the minimum detection distance Dₘᵢₙ of each of predefined postures to define the feature distance D_{feature}. FIG. 6 shows an example that a human body stand on the side of a bed and then sit on the bed, where the FMCW radar 100 is mounted on the ceiling directly above the central point of the bed, A denotes the distance from the FMCW radar 100 to the floor, D is the width of the bed, E is the height of the human body, G is the height of the bed, H is the height of the human upper body. By the above-mentioned parameters and simple trigonometric functions, the processor 200 can compute the maximum detection distance Dₘₐₓ and the minimum detection distance Dₘᵢₙ of the posture from standing to sitting. Because the momentum intensities of the detection distances from the maximum detection distance Dₘₐₓ and the minimum detection distance Dₘᵢₙ are affected by the human posture, the all detection distances between the maximum detection distance Dₘₐₓ and the minimum detection distance Dₘᵢₙ are defined as the feature distance D_{feature}, and the average value of the momentum intensities of the detection distances between the maximum detection distance Dₘₐₓ and the minimum detection distance Dₘᵢₙ is defined as the momentum feature SD_{feature} of the feature distance D_{feature}. Accordingly, the human posture can be identified when the momentum feature time-domain function SD_{feature}(t) of the feature distance D_{feature} has similar wave patterns.

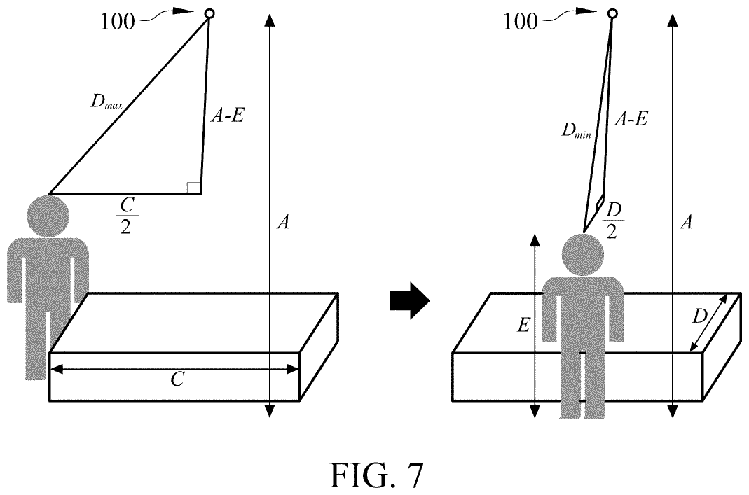

FIG. 7 represents a motion of a human body who walks to bedside from bed end, where A is the distance from the FMCW radar 100 to the floor, C is the length of the bed, E is the height of the human body, and D is the width of the bed. Similarly, the processor 200 can use the above-mentioned parameters and simple trigonometric functions to compute the maximum detection distance Dₘₐₓ and the minimum detection distance Dₘᵢₙ affected by the motion of the human body walking from bed end to bedside, define the feature distance D_{feature} using all detection distances between the maximum detection distance Dₘₐₓ and the minimum detection distance Dₘᵢₙ, and obtain the momentum feature SD_{feature} of the feature distance D_{feature} by computing the average value of the momentum intensities of the detection distances between the maximum detection distance Dₘₐₓ and the minimum detection distance Dₘᵢₙ. And also, the momentum feature time-domain function SD_{feature}(t) composed by the momentum features SD the feature D_{feature} feature of distances D_{feature} of different time segments can be used to determine the human posture body.

With reference to FIGS. 1 and 2, owing to the momentum feature time-domain function SD_{feature}(t) the feature distance D_{feature} the momentum of is intensity variation at different time segments, the processor 200 can estimate what kind of posture the object O within the region R has in the step (g). For instance, the momentum feature time-domain function SD_{feature}(t) of the feature distance D_{feature} between the maximum detection distance Dₘₐₓ and the minimum detection distance Dₘᵢₙ has significant variation when the human body sit on the bed from a standing position as shown in FIG. 6 such that the posture of the human body in the region R can be estimated. However, the object posture cannot be predicted in practice, preferably, the processor 200 defines multiple feature distances D_{feature} each corresponding to multiple detection distances and generates the momentum feature time-domain functions SD_{feature}(t) of the multiple feature distances D_{feature} in the step (f), and estimates the posture of the object O in the region R using the momentum feature time-domain functions SD_{feature}(t) of the multiple feature distances D_{feature} in the step (g).

Serious motion of object can be detected through posture estimation using the multiple feature distances D_{feature} such that the processor 200 can determine whether the object O has abnormal vital sign(s) based on the posture of the object O. For example, if it is detected that a human walking into a room lie on the side of a bed, not sit or lie on the bed, the human may be deemed to fall over or have an emergency condition so as to inform health care provider(s) instantly through alarm system to avoid regret.

In order to further enhance resolution of object posture estimation, multiple FMCW radars 100 or a single FMCW radar 100 having multiple transmitting antennas 130 may be provided to transmit multiple wireless signals S_{w} to the region R and generate the momentum feature time-domain functions SD_{feature}(t) of the more detection distances in other embodiments.

The FMCW radar 100 of the present invention is provided to obtain the momentum intensities of the detection distances such that the processor 200 can compute the momentum feature time-domain function SD_{feature}(t) of the feature distance D_{feature} composed of the detection distances to estimate object posture without problems of obstruction and privacy invasion.

The scope of the present invention is only limited by the following claims. Any alternation and modification without departing from the scope and spirit of the present invention will become apparent to those skilled in the art.

What is claimed is:

1. A posture detection method comprising steps of:
(a) transmitting a wireless signal to a region and receiving a reflected signal from the region as a detection signal by a frequency-modulated continuous wave (FMCW) radar;
(b) receiving the detection signal including a plurality of time segments and dividing one of the time segments of the detection signal into a plurality of short-time detection segments by a processor;
(c) analyzing spectrum characteristics of the short-time detection segments and reconfiguring components of the same frequency of each of the short-time detection segments into a plurality of detection sub-signals by the processor, wherein each of the detection sub-signals corresponds to a detection distance;
(d) computing a momentum intensity of the detection distance corresponding to each of the detection sub-signals by the processor according to a amplitude of each of the detection sub-signals;
(e) proceeding the steps (b) to (d) repeatedly to compute momentum intensities of detection distances of the other time segments of the detection signal by the processor;
(f) defining more than one of the detection distances as a feature distance, computing a momentum feature of the feature distance according to the momentum intensities of the feature distance and composing the momentum feature of the different time segments into a momentum feature time-domain function of the feature distance by the processor; and
(g) estimating a posture of an object in the region by the processor according to the momentum feature time-domain function of the feature distance.

2. The posture detection method in accordance with claim 1, wherein the processor is configured to define a plurality of feature distances and compute the momentum feature time-domain function of each of the feature distances in the step (f), each of the feature distances corresponds to more than one of the detection distances, and the processor is configured to estimate the posture of the object in the region according to the momentum feature time-domain function of each of the feature distances in the step (g).

3. The posture detection method in accordance with claim 2 further comprising a step (h) of estimating whether the object has an abnormal vital sign by the processor according to the posture of the object.

4. The posture detection method in accordance with claim 1, wherein the detection distances defined as the feature distance in the step (f) are the distances from the object to the FMCW radar during the posture.

5. The posture detection method in accordance with claim 1, wherein the momentum intensity of each of the detection distances is a discrete degree of the amplitude of each of the detection sub-signals.

6. The posture detection method in accordance with claim 5, wherein the momentum intensity of each of the detection distances is a standard deviation of the amplitude of each of the detection sub-signals.

7. The posture detection method in accordance with claim 1, wherein the momentum feature of the feature distance is an average value of the momentum intensities of the detection distances defined as the feature distance.

8. The posture detection method in accordance with claim 1, wherein the detection distance corresponding to each of the detection sub-signals is computed by the following formula:
$$R = \frac{{c}_{0} \cdot \vert Δ f \vert}{2 \cdot ( df / dt )}$$
wherein R is the detection distance corresponding to each of the detection sub-signals, c₀ is a speed of light of 3·10⁸ m/s, Δf is a frequency of each of the detection sub-signals, (df/dt) is a slope of a frequency variation of the wireless signal.

9. The posture detection method in accordance with claim 1, wherein the processor includes a central processing unit and a storage unit, the storage unit is electrically connected to the FMCW radar and configured to receive and storage the detection signal, the central processing unit is electrically connected to the storage unit and configured to receive the detection signal for operation.

10. The posture detection method in accordance with claim 1, wherein the FMCW radar includes a FM signal generator, a power splitter, a transmitting antenna, a receiving antenna and a mixer, the FM signal generator is configured to output a frequency-modulated signal, the power splitter is electrically connected to the FM signal generator and configured to divide the frequency-modulated signal into two paths, the transmitting antenna is electrically connected to the power splitter and configured to receive and transmit the frequency-modulated signal of one path as the wireless signal, the receiving antenna is configured to receive the reflected signal as a received signal, the mixer is electrically connected to the power splitter and the receiving antenna and configured to receive and mix the frequency-modulated signal of the other path and the received signal to output the detection signal.
